(19) United States
(12) Patent Application Publication
(10) Pub. No.: US 2023/0312049 A1
(43) Pub. Date: Oct. 5, 2023

(54) BICYCLE SUSPENSION SYSTEM

(71) Applicant: Joshua David Jorgensen, Saxilby (GB)

(72) Inventor: Joshua David Jorgensen, Saxilby (GB)

(21) Appl. No.: 17/898,316

(22) Filed: Aug. 29, 2022

Related U.S. Application Data
(60) Provisional application No. 63/318,453, filed on Mar. 10, 2022.

(51) Int. Cl. B62K 25/28

(52) U.S. Cl. CPC B62K 25/28

(57) ABSTRACT

Bicycle suspension systems are presented including: a frame for supporting a rider, where the frame includes a seat tube; a pivot assembly located proximate with a bottom portion of the seat tube; a swing arm pivotably coupled with the pivot assembly, where the swing arm is configured to resist twisting and flexing; and a pair of shocks each coupled along a distal end portion of the swing arm and coupled proximate with a top portion of the seat tube. In some embodiments, the swing arm includes: a pair of non-parallel chain stays each terminating with a rear dropout on a distal end of the pair of non-parallel chain stays; and a bridge coupled with the pair of non-parallel chain stays and positioned proximate to the pivot assembly.

### BACKGROUND

Bicycles having suspension are fairly common. Bicycle suspension may make biking more comfortable as well as safer especially where extreme biking is practiced. As suspension systems become more sophisticated, so do the costs of purchase and operation rise. For example, some systems require elaborate bracing to provide pivoting action. Other systems require additional linkage to move shock absorbing systems inboard of the seat tube. Simple effective suspension may be particularly desirable where bicyclists are engaged in more typical riding. In those cases, a suspension system that is cost effective to acquire and easy to maintain may be useful.

As such, bicycle suspension systems are presented herein.

### SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented below.

As such, bicycle suspension systems are presented including: a frame for supporting a rider, where the frame includes a seat tube; a pivot assembly located proximate with a bottom portion of the seat tube; a swing arm pivotably coupled with the pivot assembly, where the swing arm is configured to resist twisting and flexing; and a pair of shocks each coupled along a distal end portion of the swing arm and coupled proximate with a top portion of the seat tube. In some embodiments, the swing arm includes: a pair of non-parallel chain stays each terminating with a rear dropout on a distal end of the pair of non-parallel chain stays; and a bridge coupled with the pair of non-parallel chain stays and positioned proximate to the pivot assembly. In some embodiments, the swing arm further includes: an upper support member coupled with the pair of non-parallel chain stays along the distal end; and a vertical strut coupled with the upper support member and the bridge. In some embodiments, the upper support is u-shaped. In some embodiments, the pivot assembly includes: a bearing stack; and a pivot axle. In some embodiments, the swing arm and the pair of shocks form a first angle in a range of approximately 30 to 70 degrees.

In other embodiments, swing arms for use with bicycle suspension systems are presented including: a pair of non-parallel chain stays each terminating with a rear dropout on a distal end; a pair of shock mounts positioned along the distal end of the pair of non-parallel chain stays; a bridge coupling the pair of non-parallel chain stays and positioned along a proximate end portion of the non-parallel chain stays; and a pivot bracket positioned on a proximate end of the non-parallel chain stays. In some embodiments, the swing arm further includes: an upper support member coupled with the pair of non-parallel chain stays along the distal end; and a vertical strut coupled with the upper support member and the bridge. In some embodiments, the upper support is u-shaped. In some embodiments, the pivot assembly includes: a bearing stack; and a pivot axle. In some embodiments, the swing arm and the pair of shocks form a first angle in a range of approximately 30 to 70 degrees.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 includes an illustrative representation of a bicycle having a suspension system in accordance with embodiments of the present invention;

FIG. 2 includes an illustrative representation of a bicycle frame having a suspension system in accordance with embodiments of the present invention;

FIG. 3 includes an illustrative representation of a bicycle frame having a suspension system in accordance with embodiments of the present invention;

FIG. 4 includes an illustrative representation of a bicycle frame having a suspension system in accordance with embodiments of the present invention;

FIG. 5 includes illustrative representations of swing arms in accordance with embodiments of the present invention; and

FIG. 6 includes an illustrative representation of a pivot assembly in accordance with embodiments of the present invention.

### DETAILED DESCRIPTION

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

In still other instances, specific numeric references such as “first material,” may be made. However, the specific numeric reference should not be interpreted as a literal sequential order but rather interpreted that the “first material” is different than a “second material.” Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

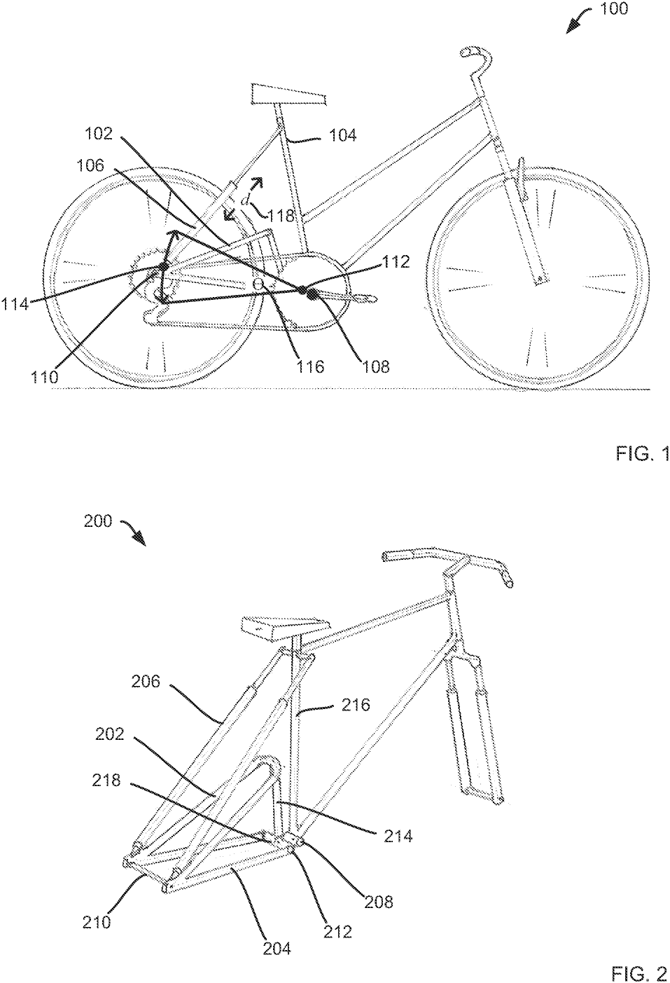

FIG. 1 includes an illustrative representation of bicycle 100 having suspension system in accordance with embodiments of the present invention. As illustrated, bicycle 100 includes a frame for supporting a rider. Seat tube 104 provides a frame member for supporting a rider and for locating various elements of the suspension system. As illustrated, swing arm 102 is coupled along a distal end portion with a pair of shocks 106. Further illustrated, swing arm 102 is pivotally coupled with pivot assembly 112 (not visible), which is located proximate with a bottom portion of seat tube 104 as well as proximate to bottom bracket 108 (not visible). In embodiments, the swing arm rotates through angle (θ) 116 less than approximately 40 degrees. In a preferred embodiment, the swing arm rotates through an angle of approximately 20 degrees. In embodiments, swing arms are rigidly constructed to prevent twisting and flexing and to ensure consistent suspension travel. Swing arms may be manufactured using any suitable material known in the art without limitation such as, for example, aluminum, carbon fiber, chromoly, and steel. In embodiments, swing arms may have a length in the range of approximately 42 cm to 45 cm. In some embodiments, the pivot assembly axis (see 112) and the bottom bracket axis (see 108) are not coaxial. In other embodiments, the pivot assembly axis and the bottom bracket axis are coaxial. Still further illustrated are shocks 106 coupled along a distal end portion 114 of swing arm 102 and coupled proximate with a top portion of seat tube 104. In embodiments, shocks may be utilized having a length in the range of 45 cm to 55 cm. In operation, swing arm embodiments allow the rear wheel to move up and down through its suspension movement range. In some embodiments, the suspension movement range (d) 118 is in a range of approximately 3.0 to 35.0 cm. As illustrated, swing arm 102 further captures rear axle 110. In some embodiments, the lower shock mount (see 114) and the rear axle (see 110) are not coaxial. In other embodiments, the lower shock mount (see 114) and the rear axle (see 110) are coaxial.

In embodiments, alignment of the rear wheel is attributable to at least two elements namely:
A) The rigidity of the swing arm;
B) The pivot assembly connection on the seat tube.

These elements function cooperatively to provide effective rear wheel suspension. In operation, the shocks slide telescopically in and out as the swing arm pivots up and down. The shocks telescope in the direction (d) 118 of a line drawn between the pivot points of the shocks. In embodiments, shocks may be adjustable to provide more or less resistance to movement. In some embodiments, a preload adjustment may be incorporated.

FIG. 2 includes an illustrative representation of bicycle frame 200 having a suspension system in accordance with embodiments of the present invention. As illustrated, bicycle 200 includes a frame for supporting a rider. Seat tube 216 provides a frame member for supporting a rider and for locating various elements of the suspension system. As illustrated, upper support member 202 is coupled with a pair of non-parallel chain stays 204 along a distal portion proximate with the rear axle 210. In the illustrated embodiment, the upper support member is u-shaped. In addition, as illustrated, vertical strut 214 couples upper support member 202 with bridge 218. Further illustrated is bottom bracket 208 and pivot assembly 212. The pivot assembly is located proximate with a bottom portion of seat tube 216 as well as proximate to bottom bracket 208. In embodiments, the swing arm and the upper support member form an angle up to approximately 60 degrees. In some embodiments, the swing arm and the upper support member form an angle in a range of approximately 15 to 50 degrees. Further illustrated are shocks 206 coupled along a distal end portion of swing arm 204 and coupled proximate with a top portion of seat tube 216. In embodiments, the swing arm and the pair of shocks form an angle in a range of approximately 30 to 70 degrees. In embodiments, shocks may be adjustable to provide more or less resistance to movement. In some embodiments, a preload adjustment may be incorporated.

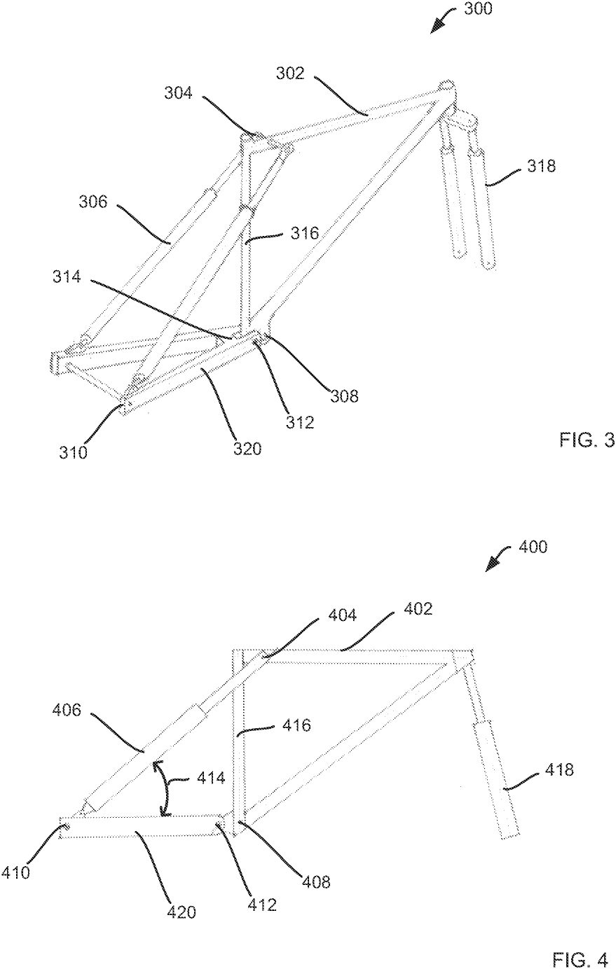

FIG. 3 includes an illustrative representation of bicycle frame 300 having a suspension system in accordance with embodiments of the present invention. As illustrated, bicycle 300 includes a frame for supporting a rider. Seat tube 316 provides a frame member for supporting a rider and for locating various elements of the suspension system. Top tube 302 provides location 304 for securing shocks 306. As illustrated, swing arm 320 includes a pair of non-parallel chain stays terminating with rear dropout 310 on a distal end that is configured for receiving a rear axle. Bridge 314 joins the pair of non-parallel chain stays along a proximate end and is located proximate to pivot assembly 312 and bottom bracket 308. The pivot assembly 312 is located proximate with a bottom portion of seat tube 316 as well as proximate to bottom bracket 308. In embodiments, the swing arm and the pair of shocks form an angle in a range of approximately 30 to 70 degrees. In embodiments, shocks may be adjustable to provide more or less resistance to movement. In some embodiments, a preload adjustment may be incorporated. Further illustrated are telescopic forks 318, which may be configured with a spring and a dampener.

FIG. 4 includes an illustrative representation of bicycle frame 400 having a suspension system in accordance with embodiments of the present invention. As illustrated, bicycle 400 includes a frame for supporting a rider. Seat tube 416 provides a frame member for supporting a rider and for locating various elements of the suspension system. Top tube 402 provides location 404 for securing shocks 406. As illustrated, swing arm 420 terminates with rear dropout 410 on a distal end that is configured to receive a rear axle. The pivot assembly 412 is located proximate with a bottom portion of seat tube 416 as well as proximate to bottom bracket 408. In embodiments, the swing arm and the pair of shocks form an angle 414 in a range of approximately 40 to 70 degrees. In embodiments, shocks may be adjustable to provide more or less resistance to movement. In some embodiments, a preload adjustment may be incorporated. Further illustrated are telescopic forks 418, which may be configured with a spring and a dampener.

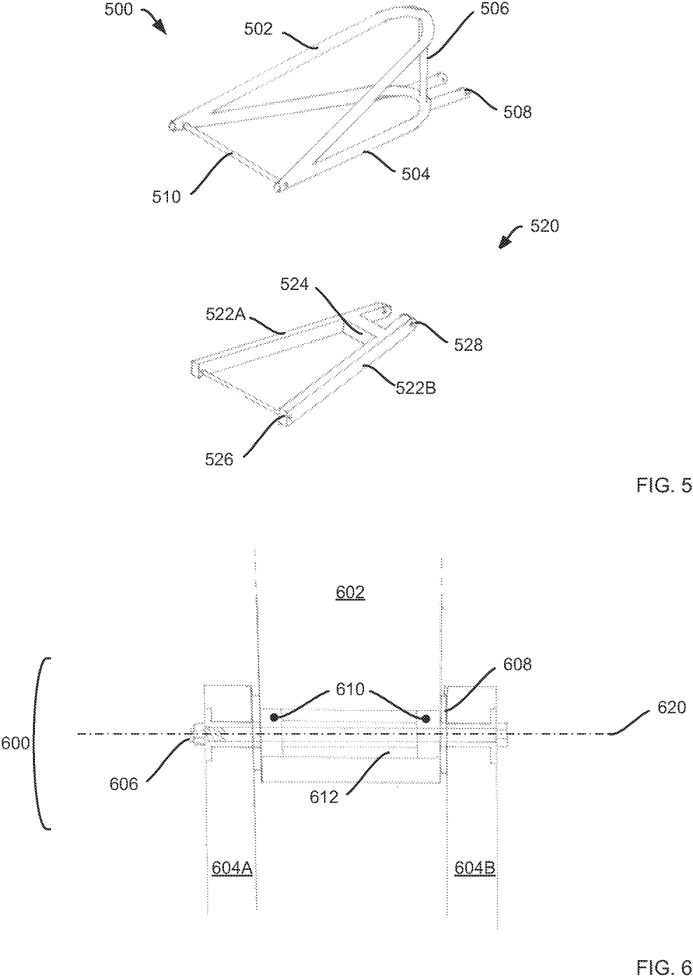

FIG. 5 includes illustrative representations of swing arms in accordance with embodiments of the present invention. As illustrated, swing arm 500 and swing arm 520 represent two embodiments for providing a swing arm. As noted above, in embodiments, swing arms are rigidly constructed to prevent twisting and flexing and to ensure consistent suspension travel. Swing arms may be manufactured using any suitable material known in the art without limitation such as, for example, aluminum, carbon fiber, chromoly, and steel. As shown, swing arm 500 may include mechanical connection points for installation with a bicycle frame. As illustrated, upper support member 502 is coupled with non-parallel chain stays 504 along a distal portion proximate with the rear axle 510. In the illustrated embodiment, the upper support member and non-parallel chain stays are each u-shaped. In addition, as illustrated, vertical strut 506 couples upper support member 502 with non-parallel chain stays 504 along the u-shaped portions. Further illustrated is pivot bracket 508. In embodiments, the pivot bracket couples with the pivot assembly forming a pivot point resistant to twisting and flexing. In embodiments, the non-parallel chain stays and the upper support member form an angle up to approximately 60 degrees. In some embodiments, the non-parallel chain stays and the upper support member form an angle in a range of approximately 15 to 50 degrees. Further illustrated is swing arm 520, which may include mechanical connection points for installation with a bicycle frame. As illustrated, swing arm 520 includes non-parallel chain stays 522A and 522B terminating with rear dropout 526 on a distal end that is configured to receive a rear axle. Bridge 524 joins the pair of non-parallel chain stays along a proximate end located proximate to pivot bracket 528 and pivotally couples with a pivot assembly.

FIG. 6 includes an illustrative representation of pivot assembly 600 in accordance with embodiments of the present invention. In embodiments, the pivot assembly is configured to allow pivoting movement without twisting or flexing. As illustrated, pivot assembly 600 bearing pivot axle 606 along axis 620 that captures chain stays 604A and 604B. Pivot assembly further includes thrust washer 608 positioned between frame 602 and the pivot brackets. Bearings 610 provide smooth pivoting movement. In some embodiments, bearings are thrust bearings. In other embodiments, bearing are open or sealed bearings. Spacer 612 may be provided in the bearing stack to maintain proper spacing between bearings.

The terms “certain embodiments”, “an embodiment”, “embodiment”, “embodiments”, “the embodiment”, “the embodiments”, “one or more embodiments”, “some embodiments”, and “one embodiment” mean one or more (but not all) embodiments unless expressly specified otherwise. The terms “including”, “comprising”, “having” and variations thereof mean “including but not limited to”, unless expressly specified otherwise. The enumerated listing of items does not imply that any or all of the items are mutually exclusive, unless expressly specified otherwise. The terms “a”, “an” and “the” mean “one or more”, unless expressly specified otherwise.

While this invention has been described in terms of several embodiments, there are alterations, permutations, and equivalents, which fall within the scope of this invention. It should also be noted that there are many alternative ways of implementing the methods and apparatuses of the present invention. Furthermore, unless explicitly stated, any method embodiments described herein are not constrained to a particular order or sequence. Further, the Abstract is provided herein for convenience and should not be employed to construe or limit the overall invention, which is expressed in the claims. It is therefore intended that the following appended claims be interpreted as including all such alterations, permutations, and equivalents as fall within the true spirit and scope of the present invention.

What is claimed is:

1. A bicycle suspension system comprising:
a frame for supporting a rider, wherein the frame includes a seat tube;
a pivot assembly located proximate with a bottom portion of the seat tube;
a swing arm pivotably coupled with the pivot assembly, wherein the swing arm is configured to resist twisting and flexing; and
a pair of shocks each coupled along a distal end portion of the swing arm and coupled proximate with a top portion of the seat tube.

2. The system of claim 1, wherein the swing arm comprises:
a pair of non-parallel chain stays each terminating with a rear dropout on a distal end of the pair of non-parallel chain stays; and
a bridge coupled with the pair of non-parallel chain stays and positioned proximate to the pivot assembly.

3. The system of claim 2, wherein the swing arm further comprises:
an upper support member coupled with the pair of non-parallel chain stays along the distal end; and
a vertical strut coupled with the upper support member and the bridge.

4. The system of claim 3, wherein the upper support is u-shaped.

5. The system of claim 1, wherein the pivot assembly comprises:
a bearing stack; and
a pivot axle.

6. The system of claim 1, wherein the swing arm and the pair of shocks form a first angle in a range of approximately 30 to 70 degrees.

7. A swing arm for use with a bicycle suspension system comprising:
a pair of non-parallel chain stays each terminating with a rear dropout on a distal end;
a pair of shock mounts positioned along the distal end of the pair of non-parallel chain stays;
a bridge coupling the pair of non-parallel chain stays and positioned along a proximate end portion of the non-parallel chain stays; and
a pivot bracket positioned on a proximate end of the non-parallel chain stays.

8. The swing arm of claim 7, wherein the swing arm further comprises:
an upper support member coupled with the pair of non-parallel chain stays along the distal end; and
a vertical strut coupled with the upper support member and the bridge.

9. The swing arm of claim 8, wherein the upper support is u-shaped.

10. The swing arm of claim 7, wherein the pivot assembly comprises:
a bearing stack; and
a pivot axle.

11. The swing arm of claim 7, wherein
the swing arm and the pair of shocks form a first angle in a range of approximately 30 to 70 degrees.
